(19) United States
(12) Patent Application Publication
(10) Pub. No.: US 2005/0275876 A1
(43) Pub. Date: Dec. 15, 2005

(54) Method and system for server-based management of requests such as print jobs

(76) Inventors: Bruce L. McLean, Lexington, KY (US); Samuel L. Rhodus, Danville, KY (US); Kenneth R. Wilkerson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/865,622

(22) Filed: Jun. 10, 2004

(51) Int. Cl. G06F 13/00

(52) U.S. Cl. 358/1.15

(57) ABSTRACT

Method and system of managing requests arriving at a central location. One embodiment of the invention provides a system for managing requests. The system includes destination paths configured to receive the requests and a server configured to receive the requests and forward each request to one of the destination paths. The system also includes an application executed on the server that intercepts the requests forwarded by the server to the destination paths, analyzes each request, extracts information from each request, and places the extracted information in a formatted output file before forwarding the request to one of the destination paths.

### FIELD OF THE INVENTION

The present invention relates to metering requests received on a server before processing. More particularly, embodiments of the invention relate to a print server managing print jobs submitted by a client application where the client application does not require a specific management interface to the print job management application executed by the print server.

### BACKGROUND OF THE INVENTION

The size and complexity of computer networks has steadily increased, and it appears that this trend will continue. As the number of users of a network increases so does the demand for printing. Network printing facilities may be misused, and printing resources including printing paper, toner, and ink wasted. Wasted printing resources are often an escalating cost for many large networks, and with numerous users utilizing network print facilities it is often difficult to supervise and manage printing resources to keep printing costs under control.

Print management systems provide network printing facility metering. Some print management systems provide print facility management by simply collecting print job data that can be used to view current printing demands and budget and plan for future costs. Other print management systems provide a more intrusive system that pauses print jobs, inspects print job characteristics, and collects additional validation data, if necessary, before it forwards the print job to a printer. The additional validation data may include a password or an account number where print charges for the print job are debited. The additional validation data may also include a simple “okay to proceed” prompt which may be required for print jobs requiring a great amount of printing resources. The prompt may serve to catch print jobs sent to an undesired printer accidentally, thereby reducing waste of print resources. Still other print management systems provide a combination of the two systems by collecting print job data and validating individual print jobs.

Large networks, including those found in businesses and universities, often employ print management systems to charge printing costs to an individual or department so that costs can be tracked and controlled. Inspecting collected print job data also provides observation of current printing patterns and more accurate predictions of future printing patterns.

Most print management systems are built with a client-server architecture. The management system requires both a client application and a server application. A specific print management application is installed on each client computer that interfaces with the print server performing the print management. Any client computer lacking the print management application is not registered with the print management system, and print jobs sent by the computer do not pass through the validation system. Obviously, installing applications on numerous computers is a tedious task. Other print management systems only recognize print jobs sent from specific applications running on a client computer, such as a word-processing or spreadsheet application. Print jobs sent from other applications are not managed by the validation system. Still other print management systems require all print job requests to travel through a specific printer driver, port, port monitor, or even an intermediary print system. Some systems create an intermediary system that collects, analyzes, and possibly validates print jobs before being sent to the true print system. In order for these types of systems to function properly, the entire print system on each client machine must be changed to the intermediary print system. Overall, even though all print job requests from all client computers or devices may arrive at a single common print server, only those print jobs that originate from a registered client computer, client application, or port, or are destined for a specific printer are validated. The remaining print jobs are not validated and pass right through the printing network unmonitored.

### SUMMARY OF THE INVENTION

In light of above, there is a need to provide an improved print management system that manages print jobs arriving at a print server.

The present invention provides among other things a system for managing requests such as print jobs. In one embodiment, the system includes one or more destination paths that receive requests. The system also includes a server that initially receives the requests and forwards each request to one of the one or more destination paths, and an application executing on the server to manage the requests. The application intercepts the requests before they reach the destination path, analyzes each intercepted request, extracts information from the requests, and places the extracted data into a formatted output file. After the application obtains the information from the request it may also hold the request for further validation, reject the request, or forward the request to one of the one or more destination paths.

In another embodiment, the invention provides a system of managing requests. In this embodiment, the system includes one or more destination paths that receive requests. The system also includes a server that receives the requests, pauses each request, obtains information regarding the requests, provides information regarding the requests if queried, and forwards each request to one or more of the destination paths. The system further includes an application executing on the server that pauses each request, queries the server for information regarding each request, and places the received information regarding each request in a formatted output file. The application may also unpause the request.

The present invention also provides a method of managing requests arriving at a central location in a computer system. In one embodiment, the method includes determining a destination path for each request, forwarding each request to the determined destination path, intercepting each request before it arrives at the destination path, and extracting information from each request. The method may also include placing the extracted data in a formatted output file and possibly forwarding the request to the determined destination path.

In yet another embodiment, the invention provides a method for managing requests arriving at a central location in a computer system. The method includes analyzing a registry of the central location to determine installed destination paths, modifying the registry to associate a request-managing intermediary with each of the installed destination paths, associating each request-managing intermediary with one of the installed destination paths, and collecting information regarding the request using the request-managing intermediaries. The method may further include providing access to the collected information.

In another embodiment, the invention provides a computer-readable medium that contains instructions for managing requests arriving at a central location. The instructions include analyzing a registry of the central location to find installed destination paths, modifying the registry to associate a request-managing intermediary with each of the installed destination paths, associating each request-managing intermediary with one of the installed destination paths, and collecting data regarding the requests using each request-managing intermediary. The medium further includes instructions for querying the central location for information regarding each request, receiving information from the central location regarding each request, and placing the received information in a formatted output file. The medium may also contain instructions for providing access to the formatted output file.

The present invention also provides a server that receives requests that are to be forwarded to one or more request destinations. The server includes a destination path for each of the one or more request destinations and a registry containing information regarding each destination path. The server may further include a spooler that receives the requests, analyzes the requests, accesses the registry, and forwards each request to one of the one or more destination paths. The server may also include a memory that holds a destination-path management application that accesses the registry, replaces the information regarding each of the destination paths with information regarding a request-managing intermediary, modifies each request-managing intermediary with the information regarding one of the destination paths, and collects data regarding the requests. The server may also include a processor to execute the destination-path management application.

In another embodiment, the invention provides a server that receives requests to be forwarded to one or more request destinations. The server includes a destination path for each of the one or more request destination paths and a registry containing information regarding each destination paths. The server may further include a spooler that receives the requests, analyzes the requests, accesses the registry, and forwards each request to one of the one or more destination paths. The server may also include a memory that holds a destination-path management application that pauses the spooler, queries the spooler for information regarding each request, receives information regarding each request from the spooler, and places the received information into a formatted output file. The destination-path management application is executed by a processor included with the server and can further unpause the spooler.

Other features and advantages of the invention will become apparent to those skilled in the art upon review of the following detailed description, claims, and drawings.

### BRIEF DESCRIPTION OF THE DRAWINGS

In the drawings:

FIG. 1 is a schematic illustration of a network printing system.

FIG. 2 is a schematic diagram of the hardware inside the print server illustrated in FIG. 1.

FIG. 3 is a schematic diagram illustrating software that may be stored in the memory module illustrated in FIG. 2.

FIG. 4 is a schematic diagram illustrating the flow of print jobs from a spooler to a destination without a management program installed and operating in a first operating mode.

FIG. 5 is a flow chart displaying a process of installing a management program to track print jobs received by a print server.

FIG. 6 is a schematic diagram illustrating the flow of print jobs from a spooler to a destination with a management program installed and operating in a first operating mode.

FIG. 7 is a flow chart displaying a process of managing print jobs arriving at a print server with a management program operating in a first operating mode.

FIG. 8 is a schematic diagram illustrating the flow of print jobs from a print spooler to a destination with a management system operating in a second operating mode.

FIG. 9 is a flow chart displaying a process of managing print jobs arriving at a print server with a management program operating in a second operating mode.

FIG. 10 illustrates a client component comprising a workstation and cursor control device shown in FIG. 1, with the display of the workstation presenting exemplary print server statistics of a print server to a user.

FIG. 11 illustrates the exemplary print server statistics shown to the user.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

Reference will now be made in detail to preferred embodiments of the invention, examples of which are illustrated in the accompanying drawings, wherein like numerals indicate the same elements throughout the views.

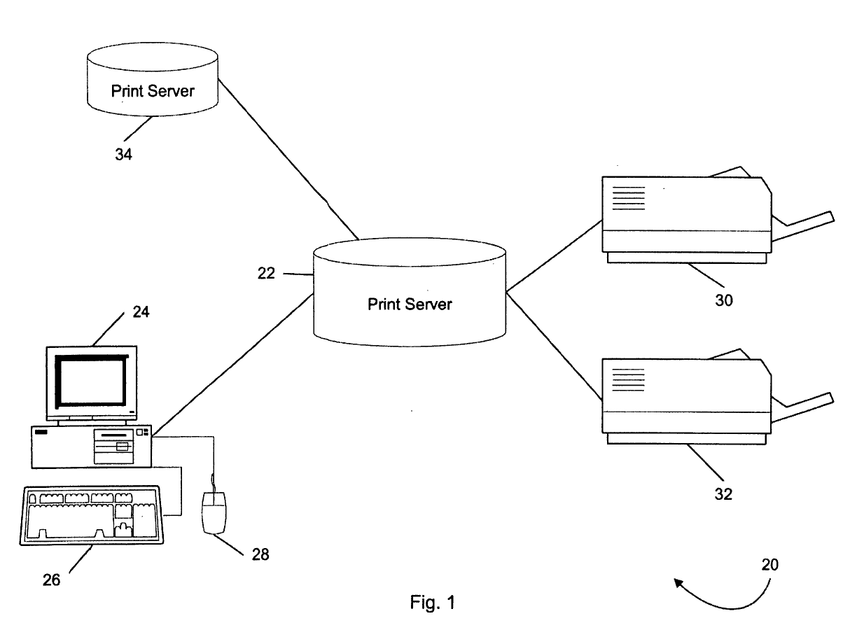

FIG. 1 illustrates an exemplary system 20 configured to validate print jobs received by a print server. In reality, one or more networks or communication systems such as the Internet, the telephone system, wireless networks, satellite networks, cable TV networks, and various other private and public networks could be used in various combinations to provide the communication links desired or needed to create embodiments or implementations of the present invention, as would be apparent to one of ordinary skill in the art. Thus, the present invention is not limited to any specific network or combinations of networks.

In the embodiment shown, the system 20 includes a central print server 22. The central print server 22 is coupled to a workstation 24 that has a keyboard 26 and a cursor control device 28, shown as a mouse. The workstation 24 acts as a client interacting with the central print server 22. The workstation 24 runs client applications (such as word processing, digital photography processing, and other software programs) that generate print jobs. The system 20 also includes printers 30, 32 coupled to the central print server 22. The printers 30, 32 act as print job, or request, destinations. Printers 30, 32 may be any device capable of performing a printing function, such as a printer or a multifunctional device which performs other functions such as copying, faxing, or scanning in addition to printing. The workstation 24 generates a print job for one of the printers 30, 32 and forwards the print job to the central print server 22. The central print server 22 then validates and routes the print job as indicated by the client application.

Although only one workstation 24 and two printers 30, 32 are shown in the illustration, the invention could be implemented as a network printing system with numerous workstations and printers. Further, there could even be multiple central print servers, although only one is required. For example, a secondary print server 34 (see FIG. 1) may also act as a client interacting with the central print server 22. The secondary print server 34 receives print jobs destined for one of the printers 30, 32 coupled to the central print server 22. The secondary print server 34 forwards the print jobs onto the central print server 22 and the central print server 22 validates and routes the print job to its final destination. It is possible that a chain of print servers could be used to route a print job to its final destination. In practice, it is likely that the following relationship will exist within the network: number of clients interacting with the central print server>number of print job destinations>number of central print servers, but again these relationships are not required and can vary.

Furthermore, other devices may be included in a network printing system. The network may include routers, gateway, switches, or hubs. Print jobs may also originate from numerous sources other than workstations. Clients interacting with the central print server 22 to service print jobs may include, but are not limited to, handheld processing devices, laptop computers, cellular telephones, printers, and facsimile machines. In general, a client may be any device capable of interfacing with the central print server 22 or any device capable of creating print jobs that can be processed by the central print server 22.

Print jobs or, more broadly, processing requests may also be destined to other devices besides printers. The central print server 22 may be configured to transfer print jobs to numerous destinations including, but not limited to, facsimile machines, files, and email inboxes. The role of client and print destination may be interchanged. For example, the central print server 22 may receive print jobs that are destined for printers or other destination devices (i.e., facsimile machines, email inboxes) which are coupled to the secondary print server 34. The central print server 22 will route the print jobs to the secondary print server 34 to service. In this situation the secondary print server 34 acts as a print job destination rather than a client as described above.

It should also be noted that other systems besides a network printing system may utilize a validation or management program. The central print server 22 could be replaced by a fax server or email server that accepts, validates, and routes fax or email jobs from client applications. The central print server 22 could also be replaced by a processor that receives processing requests from client applications for processing time and resources. The processor accepts the requests, executes the management program to validate each request and services or rejects the requests accordingly. Overall, the management program may be used at any central processing location in a network where requests or jobs are collected from numerous sources and require management.

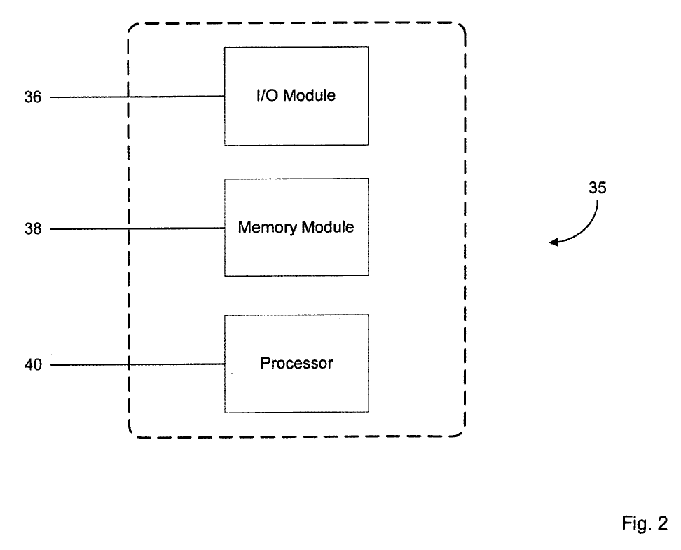

FIG. 2 illustrates hardware 35 that may be used in the central print server 22. In the exemplary configuration shown, the hardware 35 includes an I/O module 36, a memory module 38, and a processor 40. The I/O module 36 may include an interface program for receiving and forwarding print jobs. The memory module 38 may contain non-volatile memory such as one or more forms of ROM, one or more disk drives, RAM, other memory, or combinations of the foregoing. The processor 40 may be used to execute programs stored in the memory module 38 or the I/O module, such as the interface program.

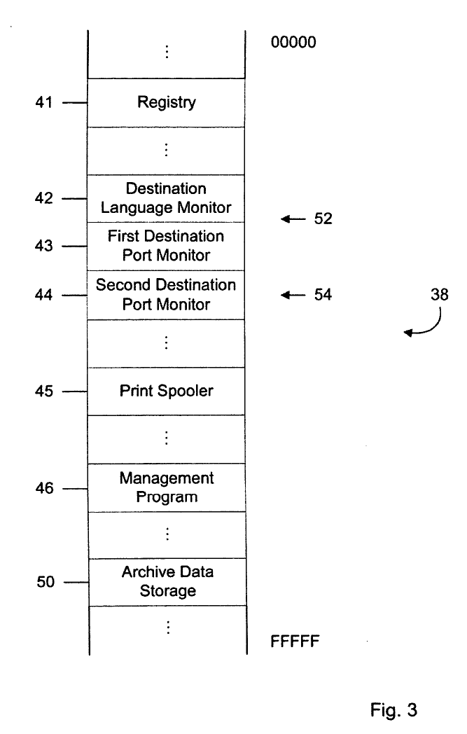

FIG. 3 illustrates the possible contents of the memory module 38 or a portion thereof. As illustrated in FIG. 3, the memory module 38 is illustrated as having seven portions each storing a set of instructions or computer code: a registry 41, a destination language monitor 42, a first port monitor 43, a second port monitor 44, a print spooler 45, a management program 46, and print archive data storage 50. In various implementations, the memory module 38 may be configured in such a way that it does not include seven distinct portions. Functional features of the memory module 38 could be combined in a variety of ways and additional features and portions could be included. For example, a separate database could replace the print archive data storage 50.

The print spooler 45 receives all print jobs submitted to the central print server 22. The print spooler 45 is capable of inspecting each received print job and determining what destination, such as a specific printer, the print job should be routed to. The print spooler 45 may have one or more print queues that act as buffers or temporary storage for the received print jobs until they are routed to their destination. The print spooler may have one print queue that holds all print jobs received by the central print server 22, a print queue for each destination device connected to the central print server 22, or any number of print queues that can be used to organize and manage the incoming print jobs received by the print spooler.

The print spooler 45 may further be configured to allow other applications to query and control the spooler. Applications that register with the print spooler may request status information concerning a received print job or a print job destination. The registered application may also pause the spooler so that it does not forward the received print job to the corresponding destination path. Registering applications with a spooler utilizes preset functions calls to the print spooler. Techniques and functions for registering applications and controlling a print spooler are known in the art.

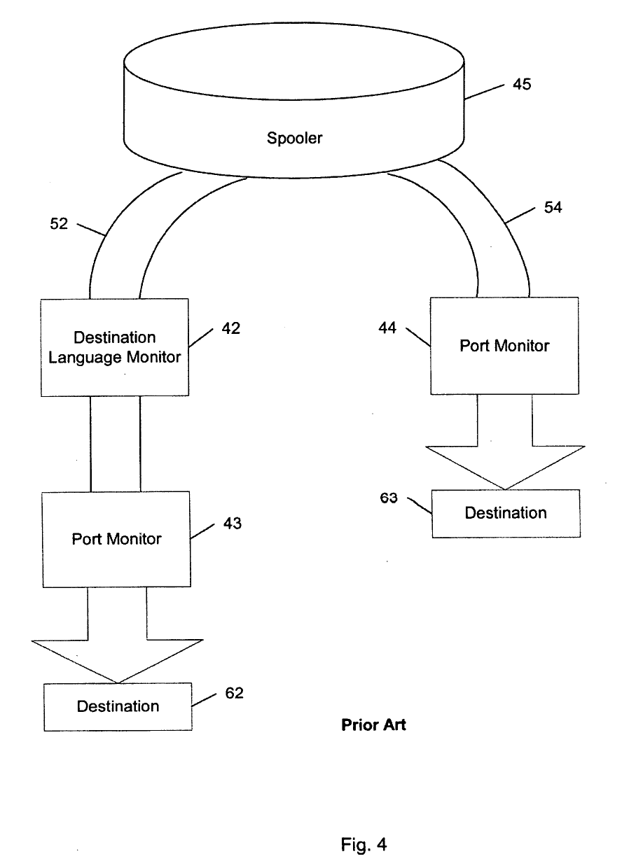

Once the print spooler 45 knows the destination of the print job and the print job has been placed in its respective print queue, the print spooler 45 or print queue uses the registry 41 to route each print job. The registry 41 contains references to all destination paths for all destinations installed on the print server. A destination path is a route that carries a print job received by the print spooler 45 to its destination. A destination path may include applications that process a print job before it arrives at its destination. As seen in FIG. 4, the destination language monitor 42 and first port monitor 43 make up a destination path 52 to destination 62. The second port monitor 44 makes up another destination path 54 leading to destination 63. A print job routed to the destination 62 by the print spooler 45 travels along the destination path 52. Since the destination path 52 includes the destination language monitor 42 and the first port monitor 43, the print job will be processed by both of these applications before it arrives at destination 62. A destination path may include multiple applications such as a language monitor and port monitor, a single application, or even no applications. When there are no intermediary applications installed to process a print job, the destination path transports the print job directly from the print spooler 45 to its destination.

The destination language monitor 42 is an application used to prepare the print job to be routed to its destination, such as a printer or secondary print server. The destination language monitor 42 includes instructions for adding commands before and after the print job in order to adjust settings of the destination of the job. The commands may include setting parameters on the printer to output the print job using certain characteristics, such as color or black ink, one-sided or two-sided, desired paper source, etc. The destination language monitor 42 may also translate the print job into a language understood by the destination of the print job so that it can be processed and correctly routed to the destination. The destination language monitor 42 is also able to obtain more information, and often more accurate information, from the print job than the spooler. Since print jobs may be generated in a precise format by a client computer for a specific printer, the language monitor can extract features of the print jobs since it knows the specific format of the print job.

The port monitors 43, 44 each act as a buffer and relay before the destination, such as a printer or other connected device. The port monitors 43, 44 receive the print job and output the print job through a port of the print server. The port monitor may be used to control the flow of data to the destination so that the destination does not receive information faster than it is able or when it is not ready to receive data. The port monitors 43, 44 may also be used as a redundant data memory that can hold data until it is successfully processed by a destination. This allows the data to be re-sent to the destination even if the destination corrupts or loses the data initially without requiring a print job to be re-sent from the client device. A printer, facsimile machine, secondary print server, etc. may be connected to a port of a print server.

The references to the destination paths installed on the print spooler 45 contained in the registry 41 may include memory locations, or pointers, or function calls that can be used to pass the print job to the start of the destination path. The references may relate to language monitors, port monitors, port addresses if no applications are installed on the destination path, or other applications or addresses. The print spooler 45 uses the registry 41 as a look-up table to find the destination path for a destination that a print job is intended for. The print spooler 45 then releases each received print job from a print queue to the corresponding destination path. The print job travels along the destination path, possibly being processed along the way, and eventually arrives at its destination.

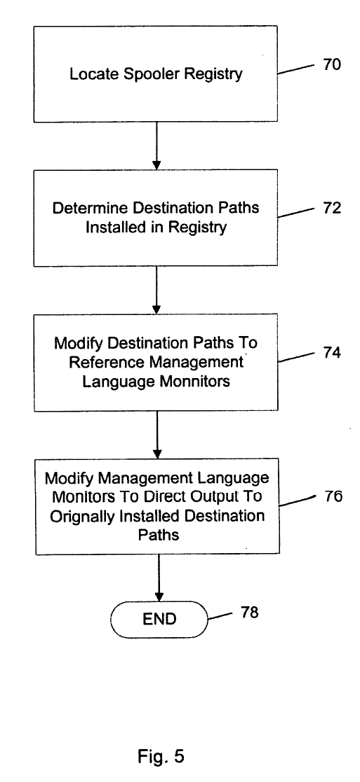

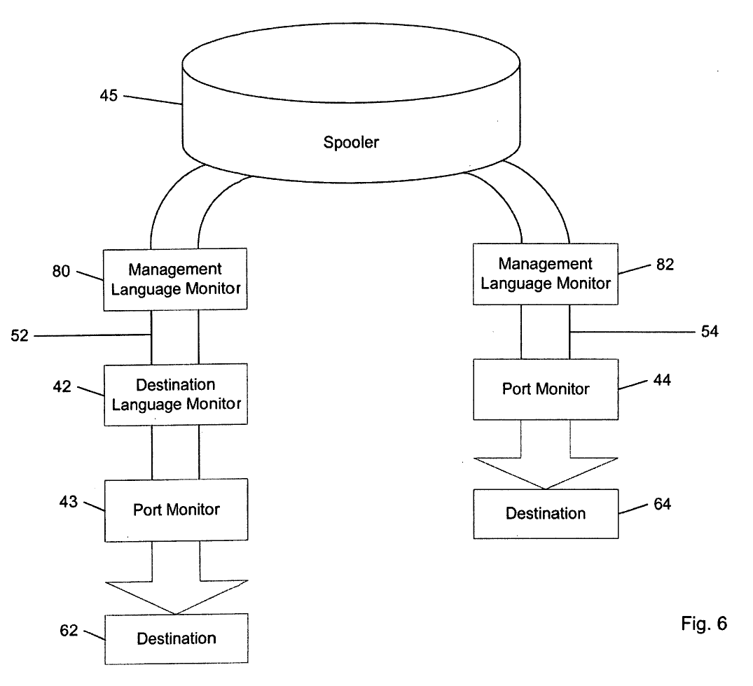

FIG. 5 illustrates an exemplary installation process carried out by the management program 46. As may be seen by referring to FIG. 5, the process begins at block 70 where the management program 46 (being executed by the processor 40 of the central print server 22) locates the registry 41 of the central print server 22. The management program 46 then determines the references of the installed destination paths contained in the registry 41 (block 72). At block 74, the management program 46 modifies or replaces the references with references to management language monitors of the management program 46. The management program 46 also modifies each of the management language monitors to include one of the original references contained in the registry 41 (block 76). The management program 46 installation is then complete (block 78). By changing the references in the registry 41, the print job data streams passed to the destination paths are now intercepted by the management language monitors. As shown in FIG. 6, the management language monitors 80, 82 act as intermediary management applications, inserted before the original start of the destination path but after the print spooler 45. A print job forwarded by the print spooler 45 is received first by one of the management language monitors 80, 82 where the print job is parsed and data regarding the print job is obtained.

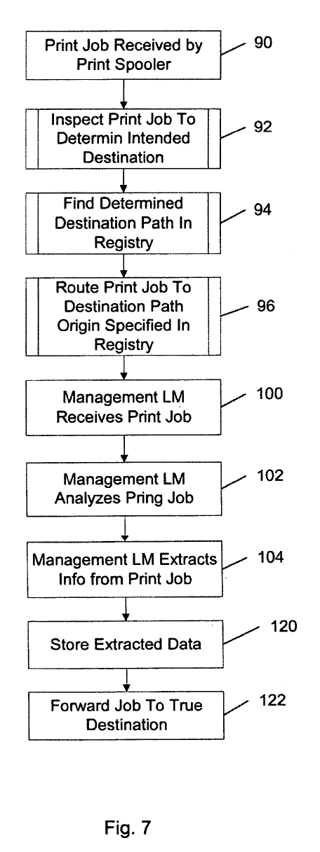

FIG. 7 illustrates an exemplary operating process carried out by the print spooler 45 upon receiving a print job with the management language monitors 80, 82 installed. At the starting block 90, the print spooler 45 receives a print job from a client device, such as the workstation 24. The print spooler 45 then inspects the received print job to determine its destination (block 92). At block 94, after the print spooler 45 determines the destination of the print job and has placed it in a corresponding print queue, the print spooler 45 uses the registry 41 to look-up the destination path corresponding to the determined destination of the print job. The print spooler 45 uses the information contained in the registry 41 to route the print job to a destination path (block 96).

Since the management program 46 altered the references in the registry to point to management language monitors 80, 82 during installation, one of the management language monitors 80, 82 receives the print job forwarded by the print spooler 45 at block 100. The management language monitor that receives the print job analyzes the print job (block 102) and extracts data from the print job (block 104). The management language monitor obtains whatever tracking information it is programmed to acquire from the print job. The management language monitor may track the originating client application, the originating owner (for example, a user identifier), the number of pages, color or black and white requirements, single-sided or double-sided requirements, graphical or textual based printing, insertion of staples, etc. of the print job. The management language monitor may also calculate additional information from the data collected from the print job. All print job data collected by the management language monitors is output to a formatted file (block 120). The file may then be accessed by the management program 46 and used provide additional tracking and validation.

The management language monitors 80, 82 may be individually programmed with specific requirements of the client to provide each destination path with tailored management. The information the management language monitors 80, 82 obtains may be changed and modified based on the changing needs and circumstances of the print network. Management language monitors 80, 82 may also be inserted for only a subset of the destination paths installed on the central print server 22.

After the management language monitor stores the obtained data, the print job is routed to the remaining destination path (block 122), which is the original destination path installed in the print spooler 45. Each management language monitor incorporates the original reference contained in the registry 41 that it overwrote. The reference may be added or modified upon installation of the management program 46 when the registry is read or may be previously programmed within each language monitor before installation. Without knowing the original reference to the destination path that it was inserted into, the language monitor does not know where the print job should be forwarded. Each management language monitor contains a reference, a pointer or function call, that will forward the print job onto the proper original destination path after the management language monitor has processed the print job.

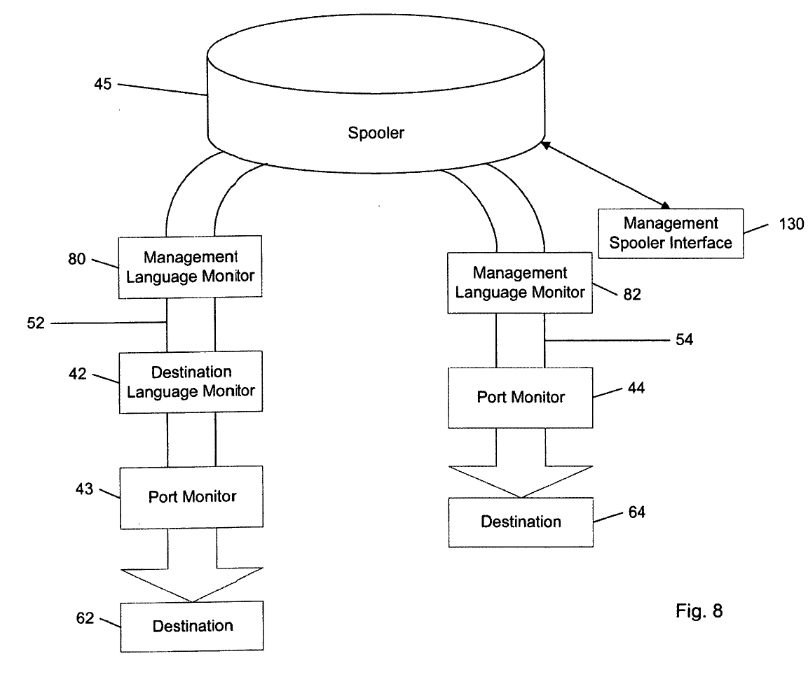

In another embodiment, if a print network requires both print job tracking and print job validation, the management program 46 may also act as a management spooler interface 130 (as seen in FIG. 8) by registering and interacting with the print spooler 45 to manage and validate print jobs. Most print spoolers, such as the print spooler in the Windows operating system, are capable of generating information concerning a print job. The print spooler 45 can determine basic characteristics of the print job including the intended destination of the print job but often know very little about the print job. The print spooler 45 often cannot determine the number of pages a print job contains unless that information is provided by the application submitting the print job. Language monitors, including the management language monitors 80, 82 may be specifically configured to obtain more precise information regarding the print jobs including whether the print job is to be printed on both sides of a page or not. In practice, the print spooler 45 generally obtains less information and less accurate information than a language monitor can since a language monitor can be configured to process print jobs with particular formats.

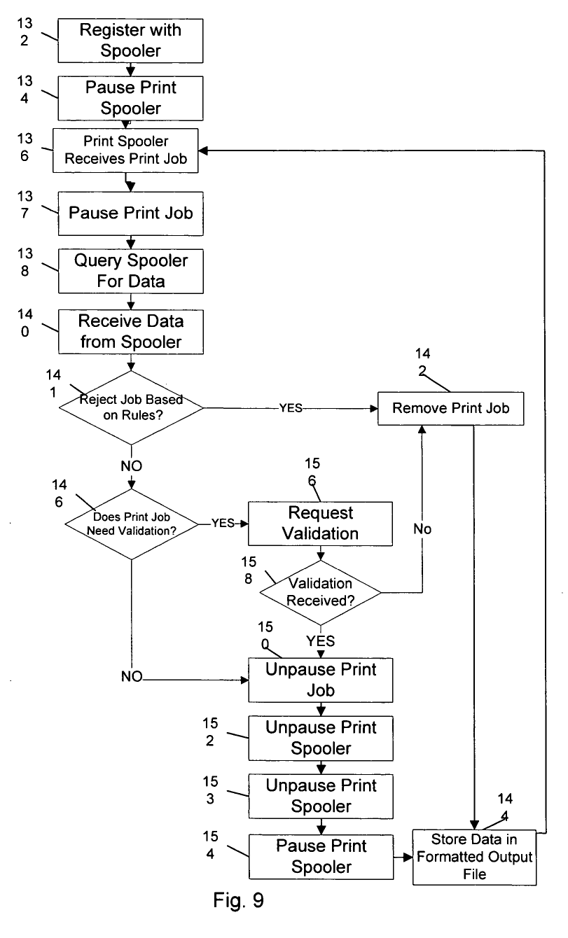

FIG. 9 illustrates an exemplary operating process of tracking and validating a print job in the embodiment of the management system illustrated in FIG. 8. Starting at block 132, the management spooler interface 130 registers with the print spooler 45 by utilizing a preset application programming interface (“API”) provided by the print spooler 45. Registering an application with a print spooler is known in the art and is similar to registering applications to forward print jobs to a print server. Once the management spooler interface 130 has registered with the print spooler 45 it may utilize the print spooler's API to query and control the print spooler 45 and/or the individual print queues that the print spooler 45 manages. At block 134, the management spooler interface 130 pauses an individual print queue so that it will not route any received print jobs. By pausing individual print queues only individual print queues holding print jobs for specific destination devices can be paused while other queues can operate normally. The management spooler interface 130 may also pause the entire print spooler 45. Functionality for pausing the entire print spooler 45 is currently not available but may be made available in future printing systems. Pausing the print spooler 45 or individual print queues may include placing the spooler or queue into an error state or condition where it is configured to not forward or route any received print jobs until the error state or condition is cleared.

At block 136, the print spooler 45 receives a print job and places the print job in a print queue based on its intended destination. Since the management spooler interface 130 is registered with the print spooler 45, it can be made aware of this event. The management spooler interface 130 may follow events of the print spooler 45 by continuously polling the print spooler 45 or may sleep while no events are occurring at the print spooler 45 and be awakened by the print spooler 45 when an event, such as the arrival of a print job, occurs. After a print job is received by the individual paused print queue, the management spooler interface 130 pauses the print job (block 137). Similar to pausing the individual print queue, pausing the print job may include placing the print job into an error condition or state which forces it to remain in the print queue or print spooler 45. At block 138, the management spooler interface 130 queries the print spooler 45 for information regarding the print job that it recently received. The management spooler interface 130 obtains from the print spooler 45 whatever tracking information it is programmed to acquire from each print job, or whatever subset of the information that is available and capable of being provided by the print spooler 45 (block 140).

At block 141, the management spooler interface 130 may decide whether it should reject the print job. The management spooler interface 130 may include a set of conditions indicating when a print job should be rejected. The conditions may relate to obtained print job information such as color print jobs or print jobs with a certain number of bytes. The conditions may also be general conditions such as rejecting all print jobs or every other print job. The management spooler interface 130 may also never reject print jobs. Rejection conditions can also be specified for only a subset of print jobs received by the print spooler 45, for example, only print jobs having certain destinations may be rejected or subjected to rejection criteria.

If the management spooler interface 130 decides that the print job should be rejected, it removes the print job from the print queue and subsequently, from the print spooler 45 (block 142). By removing the print job from the print spooler 45 the job will not be routed by the spooler to its destination. Removing the print job from the print spooler 45 may also include leaving the print job in a paused or error state where eventually the print job may time out and be deleted by the print spooler 45. The management spooler interface 130 may also store the data extracted from the print job at block 144. As described for the management language monitors, the management spooler interface 130 may store additional data not extracted from the print job such as time of rejection, or reason for rejection along with the extracted data. All data that is obtained by the management spooler interface 130 is stored as formatted files so that it may be accessed and manipulated later. After storing the extracted data, the management spooler interface 130 is ready to handle the next print job received by the print spooler 45.

If the management spooler interface 130 decides that the print job should not be rejected, it may then decide if the print job is validated for release to its destination (block 146). The management spooler interface 130 may determine if each print job is validated, or should be released to the original destination path, based on a set of rules or restrictions programmed into the management spooler interface 130 and the information obtained from the print job. The management spooler interface 130 may compare the obtained information for the print job with preset restrictions or rules and determine if validation data, such as a password or account number, is required to process the print job. In addition, the management spooler interface 130 may be programmed to require validation data for all print jobs it processes regardless of the obtained information for each print job. The management spooler interface 130 may also be programmed not to require any validation data for each print job.

If the management spooler interface 130 is not programmed to validate print jobs or if a specific print job does not require validation, the management spooler interface 130 releases the print job by unpausing the job (block 150). The unpaused print job, however, will not immediately be routed by the print queue since the print queue containing the print job is paused. At block 152, the print queue is unpaused. The unpaused print queue can then route the unpaused print job to its intended destination path as described above (block 153). The unpaused print job may be routed to a management language monitor if the management program 46 installed a monitor for the destination path of the unpaused print job. The management language monitor will then obtain additional or repetitive information regarding the unpaused print job. The management language monitors may store their obtained data in a separate formatted file or may append or overwrite the file generated by the management spooler interface 130.

If the destination path of the unpaused print job does not have an installed management language monitor, the unpaused print job will be routed, by the print queue or print spooler 45, to its true destination path. This path may include a language monitor and/or port monitor or additional applications.

After the unpaused print job has been routed, the individual print queue that previously held the unpaused print job is paused again (block 154). The individual print queue is only unpaused for the time needed to route the unpaused print job. The individual print queue is re-paused immediately thereafter so that only the unpaused print job is routed and other print jobs are not released without first being processed by the management spooler interface 130.

At block 144, the management spooler interface 130 stores any obtained data regarding the unpaused print job and an additional data such as the reason why validation data was not required or the time that is was unpaused as a formatted output file. The management spooler interface 130 may also be configured not to store any obtained data regarding the print jobs. This duty may be left to the installed management language monitors. After the management spooler interface 130 stores the obtained data, if applicable, the management spooler interface 130 is then ready to process another print job.

If, on the other hand, validation data is required, the management spooler interface 130 holds the print job by retaining the print job in a paused condition or state. Holding one print job, however, will not deter future print jobs arriving at the print spooler 45 after the held print job from being processed and released by the management spooler interface 130. By pausing individual print jobs in addition to pausing the individual print queues, the print queues can be paused and unpaused allowing other print jobs to be processed and released while jobs awaiting validation are being held. The management spooler interface 130 may also hold the print job by removing it from the print queue and subsequently, the print spooler 45. The management spooler interface 130 may place the held job it removed from the print spooler 45 in a memory location of the memory module 38 and await the next received print job. Removing the print job from the spooler also continues to allow the management spooler interface 130 to process and release future print jobs while the held print job waits for validation.

Validation is required for the held print job to be released or passed to the destination path. The management spooler interface may utilize the services of a language monitor, a port monitor, the print spooler 45, and/or a corresponding application installed on the client computer to communicate with the client computer that submitted the print job to request validation data (block 156). Validation data may also arrive from other sources than the client component that issued the print job. For example, such sources may be a database, a remote server, or another printer server. Validation data may arrive in the form of a time setting expiration. For example, all print jobs of a given size (bytes or pages) may be held until after business hours so that they do not occupy limited resources for a long period of time during normal business hours. A master controller application may also provide a printing-facility supervisor to monitor held print jobs and provide validation to the management spooler interface 130.

When validation data arrives for a held print job the management spooler interface 130 can process the received validation data and determine if the held job should be released (block 158). If the held print job is to be released based upon the validation data, the management spooler interface 130 can unpause the print job (block 150). Alternatively, if the management spooler interface 130 removed the held print job from the print spooler 45, the validated print job can be returned to the print spooler 45. The unpaused print job, however, will not be routed since the individual print queue is still paused. At blocks 152 and 153, the management spooler interface 130 unpauses the individual print queue to allow the validated print job to be forwarded and immediately re-pauses the individual print queue so that the next print job can be stopped before it is routed. The individual print queue is only unpaused for a short duration so that only one print job, which has already been tracked and possibly validated by the management spooler interface 130, is routed. The individual print queue is quickly paused again so that the next print job in the print queue can be monitored by the management spooler interface 130 before being routed to its destination. Unpausing the print job and/or print queue can include clearing an error condition that was previously set to pause the print job or queue.

As previously described, the unpaused print job is routed by the individual print queue or print spooler 45 to its destination path. The destination path of the unpaused print job may include a management language monitor that may obtain additional or repetitive information regarding the print job. The data obtained by the management language monitors may be stored in a separate formatted output file or may be appended or overwritten to the formatted file generated by the management spooler interface. The destination path of the unpaused print job may also not include a management language monitor, and the unpaused print job will be forwarded to its true, intended destination path.

Alternatively, if the management spooler interface 130 does not receive validation data or receives invalid validation data, such as an expired or incorrect password, the management spooler interface 130 may reject the print job by removing the paused print job from the print spooler 45 (block 142). The print job may also be rejected by leaving the job in a paused or error state until it is automatically deleted by the print spooler 45. The print job may also be rejected by being placed in a different error state than the initial error state such that the individual print queue or print spooler 45 immediately disregards the job. If the print job was previously paused by removing it from the print spooler, the management spooler interface 130 may not return the print job lacking validation to the print spooler 45. The management spooler interface 130 may store the extracted data of the rejected held print job (block 144) and await the next print job to arrive at the print spooler 45.

Whether the management spooler interface 130 rejects or forwards the print job, the extracted data for the print job is stored. Additional data may also be stored by the management spooler interface 130. The management spooler interface 130 may store the validation data received, the reason for release or rejection, the time the print job spent waiting for validation, etc. All the data is stored as a formatted output file in the archive data storage 50, or a separate database or other storage device, so that it can be accessed and manipulated as needed to track and analyze print system usage.

The management spooler interface 130 may also be programmed to communicate with the client device, as described above for obtaining validation data, to indicate the status of the print job. It may be useful to client devices to know whether their submitted print job was printed, held for validation, or rejected. The characteristics of the print job, such as number of pages, estimated cost, etc., may also be transmitted to the client device.

The management program 46 may operate in both modes simultaneously. If management language monitors 80, 82 are not inserted for every destination path installed on the print server, the management spooler interface 130 may be used to obtain data for those print jobs that are forwarded to destination paths where intermediary language monitors are not installed. The management spooler interface 130 may obtain whatever data it can concerning a print job and allow the print job to be forwarded to a destination path where it may be intercepted by a management language monitor. The management language monitor may acquire additional information regarding the print job and may either append or overwrite the data obtained by the management spooler interface 130 stored in the formatted output file, such as the archive data storage 50. The management spooler interface 130 and management language monitors 80, 82 may also use separate formatted output files.

Regardless of the operating mode, data tracked by the management program 46 may be converted to an extended markup language (“XML”) file or other formatted file and stored in the archive print data storage 50 or a supplemental database. In addition to XML, the data could be formatted as an email message, HTML document, a SQL statement, a comma delimited file, etc. The extracted data can be stored by sending it to an email address or posting it to an Internet site. An exemplary XML output file generated by the management program is set out below. The data shown in the “PrintJob” element is the data acquired from the print spooler 45, and the data in the “LmPrLang” element is data acquired from the print data stream by the language monitor of the management program 46.

<Event>

<PrintJob TrackingID=“1” PC=“\\XPTESTGEN”JobName=“Test Page”

User=“Administrator”JobId=“2”Queue=“Lexmark X422” Copies=“1”
Duplex=“FALSE”Color=“FALSE” PaperType=“1”
PaperTypeDesc=“Letter 8½ × 11 in″ Bytes=“62612”
Printed=“TRUE” Pages=“1”>

<Time Hour=“10” Minute=“53”Second=“32” Day=“1O”Month=“2”

Year=“2004”/ >

<LmPrLang=“PostScript” PjlWrap=“TRUE”Ptr=“Lexmark X422”

Doc=“Test Page” PageSize=“Letter”Pages=“1” Color=“TRUE”/ >

</PrintJob>

</Event>

As can be seen from the above example, the “LmPrLang” element acquires additional information such as the printer language (PrLang=“PostScript”) and also acquires more accurate information than the information acquired by the “PrintJob” element. For example, the “PrintJob” element indicated that the print job was not in color, but the “LmPrLang” element indicated that the print job was in color.

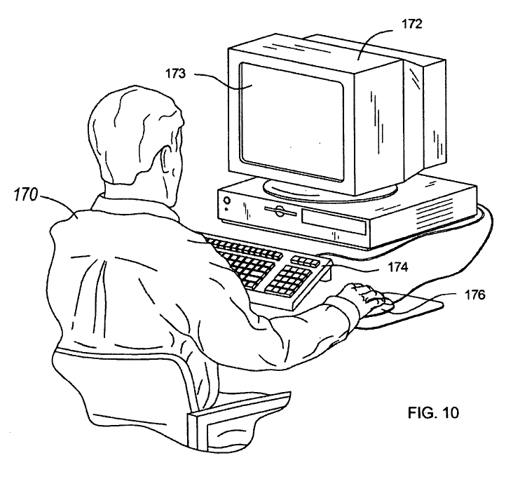

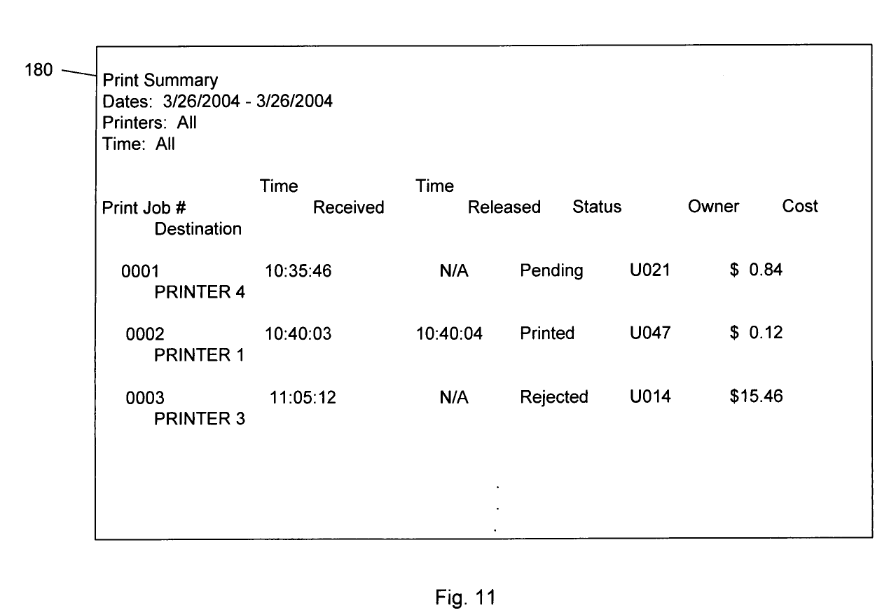

The stored formatted files may be accessed later through a user-interface provided by the management program 46 to compute statistics and view historical data. As seen in FIG. 10, a user 170 may use a workstation 172 configured with a display 173 and a keyboard 174 and a cursor control device 176, illustrated as a mouse, to interact with the management program 46. The user-interface application accesses the data stored in the archive data storage 50 and presents the data to the user 170 in a print job summary report on the display 173. The print job summary report could also be printed, saved to a file, emailed, or posted on a web-site, in addition or in place of being displayed on the display 173. An exemplary report 180 is shown in FIG. 11. The print job data summary report illustrated includes data regarding a print job number, the time of arrival and time or release for the print job, the status of the print job, the owner of the print job, the associated cost for the print job, and the print job destination. The summary report may include only some of the information displayed in the exemplary report 180, may include other information, or any combination thereof. The summary report may be specified for a particular time period, printer, print job, any other print job characteristic stored, or any combination thereof. The parameters for the summary report may be entered by the user 170 using the workstation 172 and, for example, the keyboard 174 and the cursor control device 176, or any additional devices such as a touch screen or a voice activated system.

The user 170 may also use the user-interface of the management program 46 to monitor the operation of the print server and the execution of the print management system in real-time. The user 170 may use the keyboard 174 and cursor control device 176, or additional input devices, to select particular destination drivers to manage and monitor in real-time. By selecting individual print destinations to monitor, a user 170 can focus on areas of interest or concern within a network printing system.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features and advantages of the present invention are set forth in the following claims.

1. A system for managing requests, the system comprising:
one or more destination paths configured to receive the requests;
a server configured to receive the requests and forward each request to one of the one or more destination paths; and
a first application configured to execute on the server, intercept the requests forwarded by the server to the one or more destination paths, analyze each request, and extract information from each request.

2. The system as claimed in claim 1, further comprising a second application configured to hold each request until validation information is received.

3. The system as claimed in claim 2, wherein the second application is further configured to release each request if validation information has been received.

4. The system as claimed in claim 2, wherein the second application is further configured to reject each request if validation information has not been received.

5. The system as claimed in claim 2, wherein the second application is further configured to reject each request based on a set of conditions.

6. The system as claimed in claim 1, wherein the first application is further configured to forward the request to one of the one or more request destinations.

7. The system as claimed in claim 1, wherein the first application is further configured to place the extracted information in a formatted output file.

8. A system for managing requests, the system comprising:
one or more destination paths configured to receive the requests;
a server configured to be connected to the one or more destination paths, receive the requests, obtain information regarding each request, provide information regarding each request to querying applications, and forward each request to one of the one or more destination paths; and
an application configured to execute on the server, query the server for information regarding each request received by the server, and receive information regarding each request from the server.

9. The system as claimed in claim 8, wherein the application is further configured to place the received information in a formatted output file.

10. The system as claimed in claim 9, wherein the application is further configured to provide access to the formatted output file.

11. The system as claimed in claim 8, wherein the application is further configured to pause the server.

12. The system as claimed in claim 8, wherein the application is further configured to unpause the server.

13. The system as claimed in claim 8, wherein the application is further configured to remove requests from the server.

14. The system as claimed in claim 8, wherein the application is further configured to provide requests to the server.

15. A method of managing requests arriving at a central location in a computer system, the method comprising:
determining a destination path for each request;
forwarding each request to the determined destination path;
intercepting each request before it arrives at the destination path;
extracting information from each request; and
placing the extracted information in a formatted output file.

16. The method as claimed in claim 15, further comprising holding each request until validation information is received.

17. The method as claimed in claim 15, further comprising releasing each request if validation information has been received.

18. The method as claimed in claim 15, further comprising rejecting each request if validation information has not been received.

19. The method as claimed in claim 15, further comprising rejecting each request based on a set of conditions.

20. The method as claimed in claim 15, further comprising forwarding each request to the determined destination path.

21. A method of managing requests arriving at a central location in a computer system, the method comprising:
analyzing a registry of the central location to determine installed destination paths;
modifying the registry to associate a request-managing intermediary with each of the installed destination paths;
associating each request-managing intermediary with one of the installed destination paths; and
collecting information regarding the requests using the managing request intermediaries.

22. The method as claimed in claim 21, further comprising providing access to the collected information.

23. The method as claimed in claim 21, further comprising modifying each request-managing intermediary.

24. A computer-readable medium containing instructions for managing requests arriving at a central location, the instructions comprising:
analyzing a registry of the central location to find installed destination paths;
modifying the registry to associate a request-managing intermediary with each of the installed destination paths;
associating each request-managing intermediary with one of the installed destination paths;
collecting data regarding each request using each request-managing intermediary;
querying the central location for information regarding each request;
receiving information from the central location regarding each request.

25. The computer-readable medium as claimed in claim 24, further comprising instructions for placing the received information in a formatted output file.

26. The computer-readable medium as claimed in claim 25, further comprising instructions for providing access to the formatted output file.

27. The computer-readable medium as claimed in claim 24, further comprising instructions for modifying each request-managing intermediary.

28. The computer-readable medium as claimed in claim 24, further comprising instructions for holding one of the requests for further validation.

29. The computer-readable medium as claimed in claim 24, further comprising instructions for obtaining further validation of one of the requests.

30. The computer-readable medium as claimed in claim 24, further comprising instructions for forwarding each request to one of the installed destination paths.

31. The computer-readable medium as claimed in claim 24, further comprising instructions for rejecting one of the requests.

32. The computer-readable medium as claimed in claim 24, further comprising instructions for pausing the central location.

33. The computer-readable medium as claimed in claim 24, further comprising instructions for unpausing the central location.

34. The computer-readable medium as claimed in claim 24, further comprising instructions for removing requests from the central location.

35. The computer-readable medium as claimed in claim 24, further comprising instructions for providing requests to the central location.

36. A server receiving requests to be forwarded to one or more request destinations, the server comprising:
a destination path for each one of the one or more request destinations;
a registry containing information regarding each of the destination paths;
a spooler configured to receive the requests, analyze the requests, access the registry, and forward each request to the proper destination path;
a memory configured to hold a management application configured to access the registry, replace the information regarding each of the destination paths with information regarding a request-managing intermediary, modify each request-managing intermediary, and collect data regarding the requests; and
a processor configured to execute the management application.

37. The server as claimed in claim 36, wherein the management application is further configured to provide access to the collected data.

38. A server receiving requests to be forwarded to one or more request destinations, the server comprising:
a destination path for each one of the one or more request destinations;
one or more queues configured to hold requests;
a registry containing information regarding each of the destination paths;
a spooler configured to receive the requests, analyze the requests, provide information regarding the requests to a querying application, access the registry, and forward each request to the proper destination path by placing the request into one of the one or more queues;
a memory configured to hold a management spooler interface application configured to query the spooler for information regarding the requests and receive information regarding the requests from the spooler; and
a processor configured to execute the management spooler interface application.

39. The server as claimed in claim 38, wherein the management spooler interface application is further configured to place the received information in a formatted output file.

40. The server as claimed in claim 39, wherein the management spooler interface application is further configured to provided access to the formatted output file.

41. The server as claimed in claim 38, wherein the management spooler interface application is further configured to pause the spooler.

42. The server as claimed in claim 38, wherein the management spooler interface application is further configured to unpause the spooler.

43. The server as claimed in claim 38, wherein the management spooler interface application is further configured to pause the one or more queues of the spooler.

44. The server as claimed in claim 38, wherein the management spooler interface application is further configured to unpause the one or more queues of the spooler.

45. The server as claimed in claim 38, wherein the management spooler interface application is further configured to remove requests from the spooler.

46. The server as claimed in claim 38, wherein the management spooler interface application is further configured to provide requests to the spooler.

47. A system for managing requests, the system comprising:
one or more destination paths configured to receive the requests;
a spooler configured to receive the requests and output each request to one of the one or more destination paths;
an application configured to execute on the server, intercept the requests forwarded by the spooler to the one or more destination paths, analyze each request, extract information from each request, and place the extracted information in a formatted output file.

48. A system for managing requests, the system comprising:
one or more destination paths configured to receive the requests;
a spooler configured to receive the requests, obtain information regarding each request, provide information regarding each request to querying applications, and forward each request to one of the one or more destination paths;
an application configured to execute on the server, query the spooler for information regarding each request received by the server, and receive information regarding each request from the spooler.

49. The system as claimed in claim 48, wherein the application is further configured to place the received information in a formatted output file.
